(19) United States
(12) Patent Application Publication
(10) Pub. No.: US 2026/0069971 A1
(43) Pub. Date: Mar. 12, 2026

(54) EVENT REPLAY METHOD AND APPARATUS, STORAGE MEDIUM, AND ELECTRONIC DEVICE

(71) Applicant: Tencent Technology (Shenzhen) Company Limited, Shenzhen (CN)

(72) Inventors: Chenghao ZHANG, Shenzhen (CN); Youyi XIONG, Shenzhen (CN); Kwong Yuen TSE, Shenzhen (CN)

(21) Appl. No.: 19/387,448

(22) Filed: Nov. 12, 2025

Related U.S. Application Data
(63) Continuation of application No. PCT/CN2024/136014, filed on Dec. 2, 2024.

(30) Foreign Application Priority Data
Jan. 2, 2024 (CN) 202410015844.7

(51) Int. Cl. A63F 13/497; A63F 13/52; A63F 13/837

(52) U.S. Cl. CPC A63F 13/497; A63F 13/52; A63F 13/837

(57) ABSTRACT

This application discloses an event replay method performed by an electronic device. The method includes: displaying a running picture of a mobile end game on a display of the electronic device obtained through rendering based on first game resources used during execution of a current battle in the mobile end game; receiving an event replay request by a user of the electronic device, the event replay request being configured for requesting to replay a historical game event of a virtual character in the mobile end game; obtaining reusable game resources from the first game resources; forming second game resources based on the reusable game resources, the second game resources required during rendering and playing of the historical game event; and rendering and playing a historical game event based on the second game resource during the execution of the current battle in the mobile end game.

### CROSS-REFERENCE TO RELATED APPLICATIONS

This application is a continuation application of PCT Patent Application No. PCT/CN2024/136014, entitled “EVENT REPLAY METHOD AND APPARATUS, STORAGE MEDIUM, AND ELECTRONIC DEVICE” filed on Dec. 2, 2024, which claims priority to Chinese Patent Application No. 2024100158447, entitled “REAL-TIME PLAYING METHOD AND APPARATUS FOR EVENT REPLAY, STORAGE MEDIUM, AND ELECTRONIC DEVICE” filed with the China National Intellectual Property Administration on Jan. 2, 2024, all of which is incorporated herein by reference in their entirety.

### FIELD OF THE TECHNOLOGY

This application relates to the field of computers, and specifically, to a game event replay technology.

### BACKGROUND OF THE DISCLOSURE

A real-time playing function for event replay is usually deployed in a personal computer (PC) end game. The real-time playing function deployed on a PC end has large overheads for performance of an internal memory and a central processing unit (CPU), and therefore is not applicable to a mobile end game, resulting in a problem that real-time playing for event replay is not applicable to the mobile end game.

### SUMMARY

Embodiments of this application provide an event replay method and apparatus, a storage medium, and an electronic device, to resolve at least a technical problem that real-time playing for event replay is not applicable to a mobile end game.

According to an aspect of embodiments of this application, an event replay method is performed by an electronic device, the method including: displaying a running picture of a mobile end game on a display of the electronic device obtained through rendering based on first game resources used during execution of a current battle in the mobile end game; receiving an event replay request by a user of the electronic device, the event replay request being configured for requesting to replay a historical game event of a virtual character in the mobile end game; obtaining reusable game resources from the first game resources; forming second game resources based on the reusable game resources, the second game resources required during rendering and playing of the historical game event; and rendering and playing the historical game event based on the second game resource during the execution of the current battle in the mobile end game.

According to still another aspect of embodiments of this application, an electronic device is further provided, including a memory, a processor, and a computer program stored in the memory, and the computer program, when executed by the processor, causing the electronic device to perform the foregoing event replay method by using the computer program.

According to still another aspect of embodiments of this application, a non-transitory computer-readable storage medium is further provided, including a memory, a processor, and a computer program stored in the memory, and the computer program, when executed by a processor of an electronic device, causes the electronic device to perform the foregoing event replay method by using the computer program.

In embodiments of this application, the running picture of the mobile end game is displayed, the running picture being the picture obtained through rendering based on the first game resources, and the first game resource being the game resource used during the execution of the current battle in the mobile end game; the reusable game resources are obtained from the first game resources, and the second game resource is formed based on the reusable game resources in response to the event replay request, the event replay request being configured for requesting to replay the historical game event of the virtual character, and the second game resource being the game resource required during the rendering and playing of the historical game event; and the historical game event is rendered and played based on the second game resource during the execution of the current battle in the mobile end game. The second game resource required during the playing of the historical game event is formed by reusing a part of game resources (the reusable game resources) from the first game resources used during the execution of the current battle in the mobile end game, so that a redundant operation of creating a new game resource is omitted, and then performance overheads caused by the redundant operation are reduced, thereby achieving technical effects of improving an adaptation degree of real-time playing for event replay in the mobile end game, and further resolving a technical problem that the real-time playing for event replay is not applicable to the mobile end game.

### BRIEF DESCRIPTION OF THE DISCLOSURE

The accompanying drawings described herein are configured for providing a further understanding of this application, and constitute a part of this application. Exemplary embodiments of this application and descriptions thereof are intended to explain this application, and do not constitute an inappropriate limitation to this application. In the accompanying drawings:

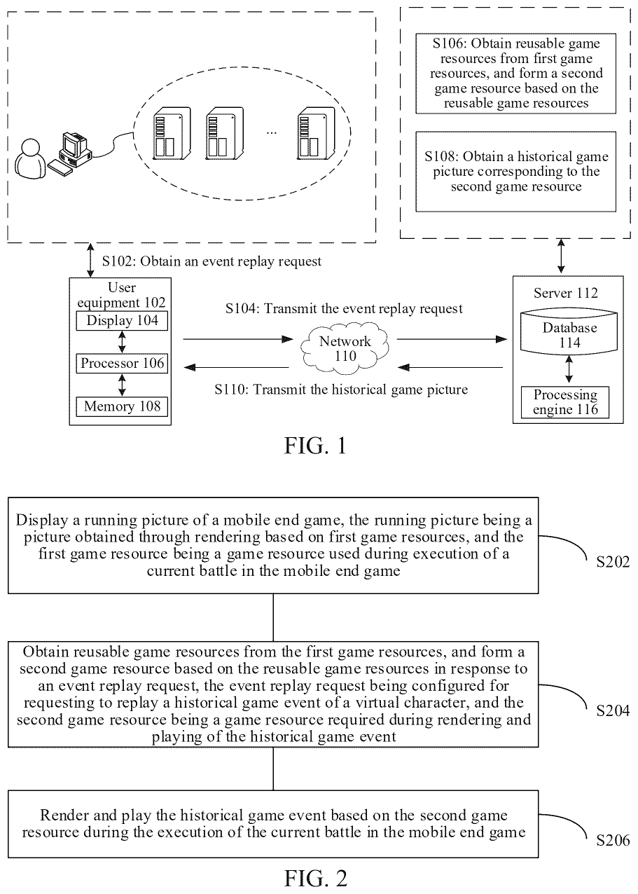

FIG. 1 is a schematic diagram of an application environment of an exemplary event replay method according to an embodiment of this application.

FIG. 2 is a schematic flowchart of an exemplary event replay method according to an embodiment of this application.

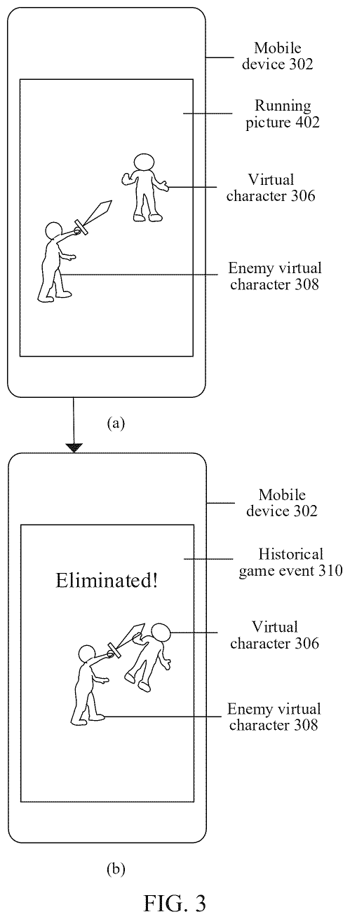

FIG. 3 is a schematic diagram of an exemplary event replay method according to an embodiment of this application.

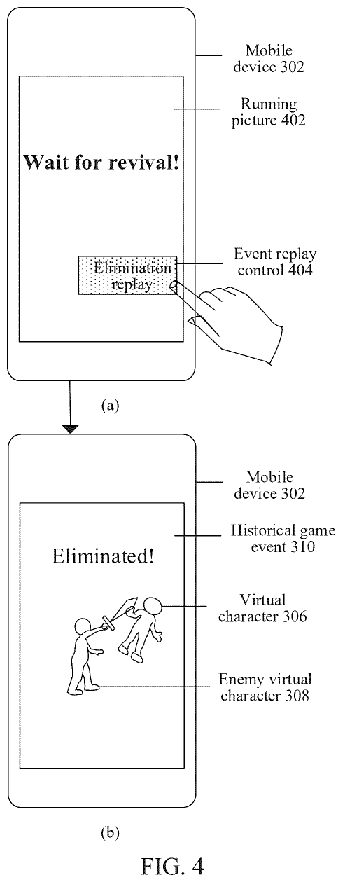

FIG. 4 is a schematic diagram of another exemplary event replay method according to an embodiment of this application.

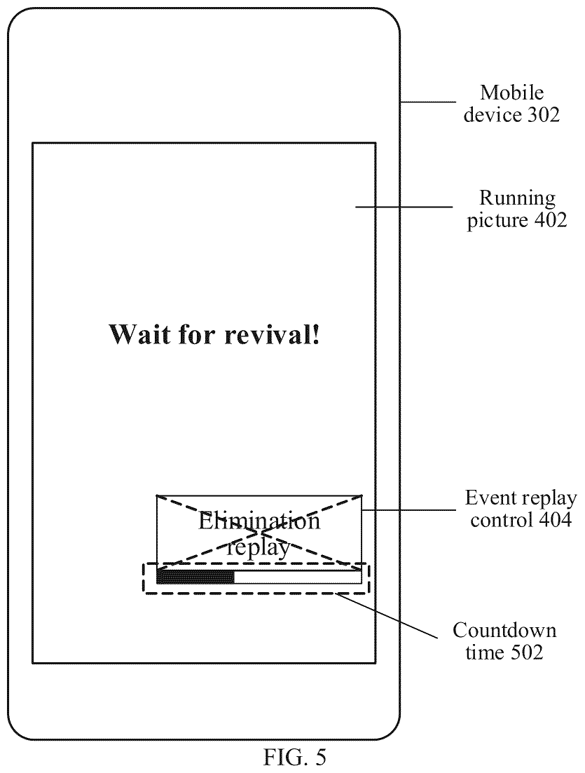

FIG. 5 is a schematic diagram of another exemplary event replay method according to an embodiment of this application.

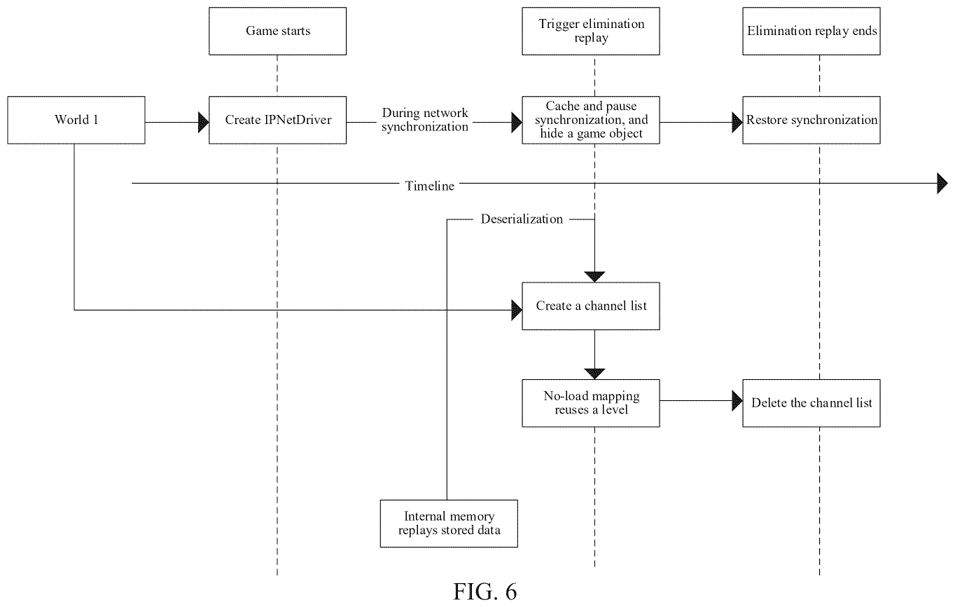

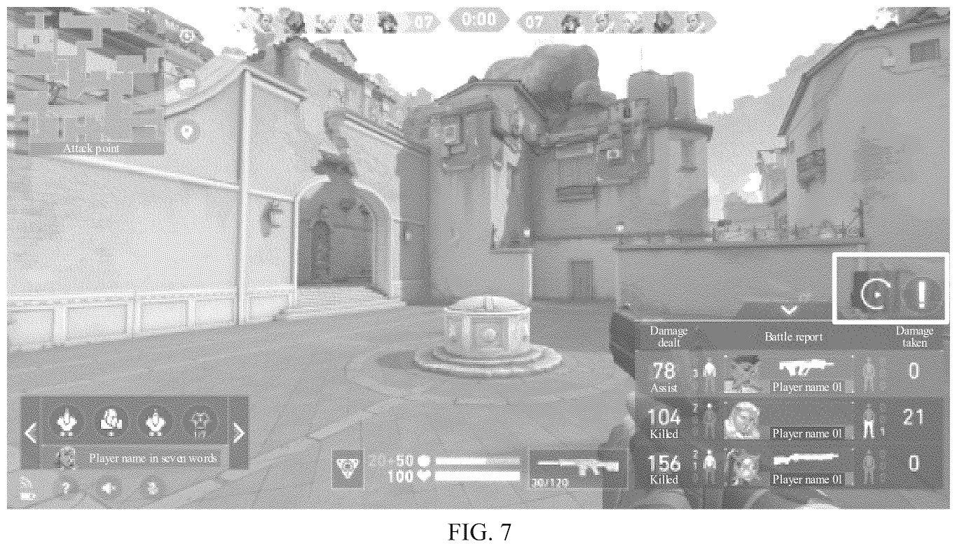

FIG. 6 is a schematic diagram of another exemplary event replay method according to an embodiment of this application.

FIG. 7 is a schematic diagram of another exemplary event replay method according to an embodiment of this application.

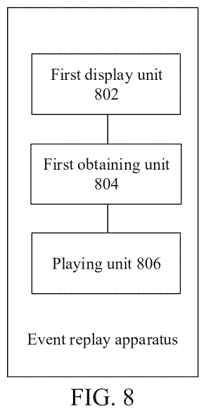

FIG. 8 is a schematic diagram of an exemplary event replay apparatus according to an embodiment of this application.

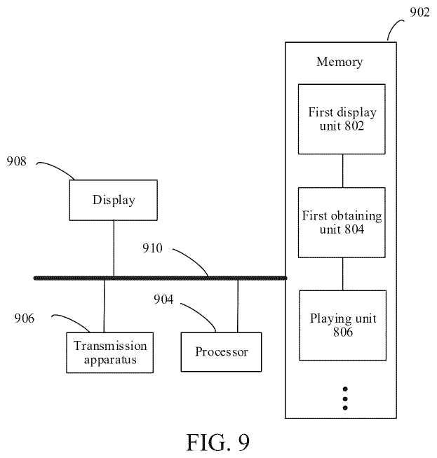

FIG. 9 is a schematic diagram of a structure of an exemplary electronic device according to an embodiment of this application.

### DESCRIPTION OF EMBODIMENTS

To make a person skilled in the art better understand the solutions of this application, the following clearly and completely describes the technical solutions in embodiments of this application with reference to the accompanying drawings in embodiments of this application. It is clear that the described embodiments are a part rather than all of embodiments of this application. All other embodiments obtained by a person of ordinary skill in the art based on embodiments of this application without creative efforts shall fall within the protection scope of this application.

In the specification, the claims, and the accompanying drawings of this application, terms such as “first” and “second” are used for distinguishing between similar objects, and are not necessarily used for describing a specific order or sequence. Data used in this way is interchangeable in an appropriate case, so that embodiments of this application described herein can be implemented in a sequence other than the sequences illustrated or described herein. In addition, terms “include”, “have”, and any variants thereof are intended to cover a non-exclusive inclusion. For example, a process, a method, a system, a product, or a device that includes a series of operations or units is not necessarily limited to those operations or units expressly listed, but may include other operations or units not expressly listed or inherent to such a process, method, product, or device.

An unreal engine 4 (UE 4) is a game engine developed by Epic Games, and is widely used for developing shooting games.

A video recording system records a game process for later replay by saving network data of a server as a file.

Elimination replay: In a first-person shooting (FPS) game, after a character is eliminated, a process in which the character is positioned, aimed, and shot is usually replayed at an enemy viewing angle.

According to an aspect of embodiments of this application, an event replay method is provided. In an exemplary implementation, the event replay method may be applied to, but is not limited to, an environment shown in FIG. 1. The environment may include, but is not limited to, user equipment 102 and a server 112. The user equipment 102 may include, but is not limited to, a display 104, a processor 106, and a memory 108. The server 112 may include, but is not limited to, a database 114 and a processing engine 116.

A specific process may include the following operations:
Operation S102: The user equipment 102 obtains an event replay request.
Operation S104: Transmit the event replay request to the server 112 via a network 110.
Operation S106 and operation S108: The server 112 obtains reusable game resources from first game resources, and forms a second game resource based on the reusable game resources in response to the event replay request by using the processing engine 116, and further obtains a historical game picture corresponding to the second game resource.

Operation S110: Transmit the historical game picture to the user equipment 102 via the network 110, and the user equipment 102 displays the historical game picture on the display 104 by using the processor 106 and stores the historical game picture in the memory 108.

In addition to the example shown in FIG. 1, the foregoing operations may be independently completed by the user equipment or the server, or may be jointly completed by the user equipment and the server. For example, the user equipment 102 performs the foregoing operations such as S106 and S108, to reduce processing pressure of the server 112. The user equipment 102 includes, but is not limited to, a handheld device (for example, a mobile phone), a notebook computer, a tablet computer, a desktop computer, a vehicle-mounted device, a smart television, and the like. A specific implementation of the user equipment 102 is not limited in this application. The server 112 may be a single server, a server cluster including a plurality of servers, or a cloud server.

In an exemplary implementation, as shown in FIG. 2, the event replay method may be performed by an electronic device, for example, the user equipment or the server shown in FIG. 1, and specific operations include:
S202: Display a running picture of a mobile end game, the running picture being a picture obtained through rendering based on first game resources, and the first game resource being a game resource used during execution of a current battle in the mobile end game.
S204: Obtain reusable game resources from the first game resources, and form a second game resource based on the reusable game resources in response to an event replay request, the event replay request being configured for requesting to replay a historical game event of a virtual character, and the second game resource being a game resource required during rendering and playing of the historical game event.

S206: Render and play the historical game event based on the second game resource during the execution of the current battle in the mobile end game.

In this embodiment, the event replay method may be applied to a first-person shooting (FPS) game on a mobile end, but is not limited thereto, and after a character (the virtual character) is eliminated, a process (the historical game event) in which the character is positioned, aimed, and shot is usually replayed at an enemy viewing angle.

In this embodiment, the mobile end game is a virtual game in which the virtual character participates and that runs on a mobile device. In the mobile end game, a player usually manipulates the virtual character by touching a screen or using an external device. The virtual character may perform various activities in a virtual environment, including, but not limited to, movement, jumping, attack, defense, and the like. In addition, the virtual character can be eliminated at least twice in a battle in the mobile end game, and a battle victory condition of the mobile end game may be associated with elimination, but is not limited thereto. For example, a camp with fewer quantity of virtual character eliminations achieves a battle victory.

In this embodiment, the historical game event may be, but is not limited to, a specified historical game event, or any historical game event. The specified historical game event may be, but is not limited to, a game event that is of a specified type and that the virtual character has experienced in the mobile end game, and the any historical game event may be, but is not limited to, a game event that is of any type and that the virtual character has experienced in the mobile end game.

Specifically, it is assumed that the specified type is a specified task type. In this case, when the virtual character experiences a game event A of a task type A in the mobile end game, and the task type A is a specified task type, the game event A may be used as a specified historical game event. Alternatively, it is assumed that the specified type is a specified interaction type. In this case, when the virtual character experiences a game event B in the mobile end game, and the virtual character interacts with a virtual character of the specified interaction type in the game event B, the game event B may be used as a specified historical game event. Alternatively, for example, the specified type is a type of a special event. For example, it is assumed that an event that the virtual character is eliminated in the mobile end game is used as the special event. In this case, when a virtually manipulated character is eliminated in the mobile end game, the elimination event may be used as a specified historical game event.

An example is further used for description. For example, when the virtual character manipulated by the player loses a hit point in the game, or meets another elimination condition, the virtual character is converted from a non-eliminated state into an eliminated state. In this embodiment, this process may be referred to as an elimination process of the virtual character (the historical game event), but is not limited thereto. In the historical game event, the virtual character may lose a control right for the game picture, but is not limited thereto, and cannot continue to participate in the game. In addition, in this embodiment, the mobile end game may play an elimination animation or effect (play the historical game event), but is not limited thereto, to display the eliminated state of the virtual character to the player. The animation or the effect may include falling down, dissipation, or another visual effect of the character, to create an atmosphere of a failure or an end. In addition to visual representation, the mobile end game may also emit sound effects or text prompts, to further clarify the eliminated state of the virtual character. The effects and prompts may help the player better understand a fact that the virtual character has been eliminated, and remind the player that the game needs to be restarted or another operation needs to be performed.

In this embodiment, the first game resource is the game resource used during the execution of the current battle in the mobile end game, for example, a character resource (a virtual character that can be selected by the player in the game), a scene resource (providing different game scenes and combat environments for the player), a prop resource (a prop that can be obtained and used by the player in the game), a sound effect resource (various sound effects used in the game), a plot resource (storylines and task clues presented in the game), an interaction resource (providing an interaction function for a plurality of accounts in the game), or an image resource (an image presented in the game).

In this embodiment, the running picture of the mobile end game is the picture obtained through rendering based on the first game resources. The rendering may be understood as converting the game resource (for example, a character, a map, or a prop) into an image or an animation that can be displayed on the screen, but is not limited thereto. In the mobile end game, the rendering is usually completed by a game engine. The game engine may be, but is not limited to, a software tool configured to create and manage a game picture, and is responsible for converting the game resource into the image that can be displayed on the screen and performing drawing and displaying by using a graphics processing unit (GPU).

In this embodiment, the event replay request is configured for requesting to play the historical game event of the virtual character. Based on the event replay request, the player can re-view performance of the virtual character that is manipulated by the player in the game, including operations such as movement, attack, and defense of the virtual character, or interaction with another character or an enemy. Such a replay function can provide more reflection and learning opportunities for the player, to help the player continuously improve skills and tactical levels in the game. In addition, to provide better user experience, in this embodiment, a replay video recording may be further saved locally or in the cloud for viewing on another device or platform, but is not limited thereto. In this way, the player can review game performance of the player anytime and anywhere, and share an elimination experience of the player with friends, to increase social interactivity of the game.

In this embodiment, the reusable game resource is a resource that is extracted from the first game resources and that is reusable in another scenario or process. The reusable game resource may be various elements and effects in the game, such as a texture, a model, a sound, and an object. The second game resource is formed based on the reusable game resources, and is the game resource required during the rendering and playing of the historical game event. These resources may include a specific character model, animation, sound effect, and the like, and are configured for presenting visual and auditory effects of the virtual character in the historical game event (for example, when being eliminated). The reusable game resources are obtained from the first game resources, and based on the reusable game resources, the second game resource required during the rendering and playing of the historical game event is formed, so that the game can be more efficiently developed, and repeated work and a waste are reduced.

In this embodiment, when playing the historical game event, the game engine presents a corresponding character model, animation, sound effect, and the like to the player in a replay manner based on a setting and a requirement of the second game resource. For example, falling down, dissipation, or another visual effect of the character, and elimination of a related enemy character may be included.

The second game resource required during the playing of the historical game event is formed by reusing a part of game resources (the reusable game resources) from the first game resources used in the current battle in the mobile end game, so that an operation of creating a new game resource is omitted, and performance overheads caused by the operation are correspondingly reduced, thereby achieving technical effects of improving an adaptation degree of executing event replay in real time in response to the event replay request in the mobile end game.

An example is further used for description. For example, as shown in (a) in FIG. 3, a running picture 304 of a mobile end game is displayed, the running picture 304 being a picture obtained through rendering based on first game resources, the first game resource being a game resource used during execution of a current battle in the mobile end game, and the mobile end game being a virtual game in which a virtual character 306 participates (and an enemy virtual character 308 participates) and that runs on a mobile device 302. Further, reusable game resources are obtained from the first game resources, and a second game resource is formed based on the reusable game resources in response to an event replay request. Assuming that a historical game event is a historical event that the virtual character 306 is eliminated by the enemy virtual character 308, the event replay request is configured for requesting to replay the historical game event 310 that the virtually manipulated character 306 is eliminated. In addition, the historical game event 310 may also be understood an event that enables the virtual character 306 to be converted from a non-end state into an end state, and the second game resource is a game resource required during playing of the historical game event 310. Furthermore, as shown in (b) in FIG. 3, the historical game event 310 is rendered and played based on the second game resource during the execution of the current battle in the mobile end game.

According to the embodiment provided in this application, the running picture of the mobile end game is displayed, the running picture being the picture obtained through rendering based on the first game resources, and the first game resource being the game resource used during the execution of the current battle in the mobile end game; the reusable game resources are obtained from the first game resources, and the second game resource is formed based on the reusable game resources in response to the event replay request, the event replay request being configured for requesting to replay the historical game event of the virtual character, and the second game resource being the game resource required during the playing of the historical game event; and the historical game event is rendered and played based on the second game resource during the execution of the current battle in the mobile end game. The second game resource required during the playing of the historical game event is formed by reusing a part of game resources (the reusable game resources) from the first game resources used during the execution of the current battle in the mobile end game, so that a redundant operation of creating a new game resource is omitted, and then an objective of reducing performance overheads caused by the redundant operation is achieved, thereby achieving technical effects of improving an adaptation degree of executing event replay in real time in response to the event replay request in the mobile end game.

In an exemplary solution, before the reusable game resources are obtained from the first game resources, and the second game resource are formed based on the reusable game resources in response to the event replay request, the method further includes the following operations.
S1-1: Display an event replay control when the historical game event is in an end state, the historical game event in the end state being set to prohibit a change.
S1-2: Initiate the event replay request in response to a replay trigger operation executed based on the event replay control.

To improve operation intuitiveness of event replay, the event replay control is displayed when the historical game event is in the end state, and the player may trigger real-time playing for event replay by executing the replay trigger operation based on the event replay control.

An example is further used for description. Based on the scenario shown in FIG. 3, for example, as shown in (a) in FIG. 4, when the virtual character 306 is in a character eliminated state (where prompt information of “wait for revival” is displayed on a running picture 402), it is considered that the historical game event is in the end state, and then an event replay control 404 is displayed. The virtual character 306 in the character eliminated state is set to prohibit manipulation. Further, in response to a replay trigger operation executed based on the event replay control 404, as shown in (b) in FIG. 4, the historical game event 310 is played.

According to the embodiment provided in this application, when the historical game event is in the end state, the event replay control is displayed, the historical game event in the end state being set to prohibit the change; and the event replay request is triggered in response to the replay trigger operation executed based on the event replay control, thereby achieving an objective of triggering real-time playing for event replay by executing the replay trigger operation based on the event replay control, and further achieving technical effects of improving the operation intuitiveness of event replay.

In an exemplary solution, during displaying of the event replay control, the method further includes the following operations.
S2-1: Display the event replay control in an operation prohibited state and countdown time of the operation prohibited state, the event replay control in the operation prohibited state being set to prohibit execution of the replay trigger operation.
S2-2: Display the event replay control in an operation allowed state when the countdown time of the operation prohibited state is cleared, the event replay control in the operation allowed state being set to allow the execution of the replay trigger operation.

To avoid a problem of information leakage caused by event replay, when the historical game event is in the end state, a state of the event replay control is first set to the operation prohibited state, and the countdown time of the operation prohibited state is set, the countdown time being duration of the operation prohibited state. In this way, in time when information leakage easily occurs, the replay trigger operation is prohibited from being executed based on the event replay control, thereby avoiding the problem of information leakage, and further improving user experience of event replay.

Furthermore, to replay the historical game event, the reusable game resources need to be obtained from the first game resources, and the second game resource needs to be formed based on the reusable game resources. To avoid excessive performance pressure caused in such a process on the mobile device, the countdown time of the operation prohibited state is set, so that the process has sufficient time for execution, and a time issue does not need to be considered because there is no need to invoke excessive resources.

An example is further used for description. Based on the scenario shown in FIG. 4, for example, as shown in FIG. 5, the event replay control 404 in the operation prohibited state and countdown time 502 of the operation prohibited state are displayed. For example, the countdown time is displayed in a progress bar manner, and the progress bar is not cleared. In this case, the event replay control 404 remains to be prohibited from executing the replay trigger operation.

According to the embodiment provided in this application, the event replay control in the operation prohibited state and the countdown time of the operation prohibited state are displayed, the event replay control in the operation prohibited state being set to prohibit the execution of the replay trigger operation; and the event replay control in the operation allowed state is displayed when the countdown time of the operation prohibited state is cleared, the event replay control in the operation allowed state being set to allow the execution of the replay trigger operation. In this way, the problem of information leakage caused by event replay is avoided, and the objective of avoiding the excessive performance pressure caused in the event replay process on the mobile device is achieved, thereby achieving technical effects of improving the user experience of event replay.

In an exemplary solution, obtaining the reusable game resources from the first game resources includes at least one of the following operations.
S3-1: Obtain a reusable scene resource from the first game resources, the scene resource being a resource required during rendering of a game scene of the current battle.
S3-2: Obtain a reusable object resource from the first game resources, the object resource being a resource required during rendering of a game object related to the historical game event in the current battle.

In this embodiment, the scene resource is the resource required during the rendering of the game scene of the current battle, and usually includes a texture, a model, illumination, a special effect, and the like. These resources are important components of the game scene, and are configured for presenting an appearance and an effect of the game scene in a rendering process. In the mobile end game, the scene resource is usually designed and manufactured based on different game scenes, to provide corresponding visual effects and game experience. The reusable scene resource is obtained from the first game resources, so that the scene resource can be reused to construct a corresponding game scene, thereby saving time and resource costs of event replay.

In this embodiment, the object resource may be, but is not limited to, the resource required during the rendering of the game object related to the historical game event in the current battle. The game object may include a character, a prop, a building, and the like. Correspondingly, the object resource is configured for presenting a specific game element and object in the game. In the mobile end game, the object resource is usually designed and manufactured based on different game objects, to provide corresponding visual effects and game experience. The reusable object resource is obtained from the first game resources, so that the object resource can be reused to construct a corresponding game object, to restore a corresponding game process, thereby saving the time and the resource costs of event replay.

To improve diversity of the reusable game resources, the reusable scene resource and/or the reusable object resource may be obtained from the first game resources.

According to the embodiment provided in this application, the reusable scene resource is obtained from the first game resources, the scene resource being the resource required during the rendering of the game scene of the current battle; and the reusable object resource is obtained from the first game resources, the object resource being the resource required during the rendering of the game object related to the historical game event in the current battle, thereby achieving an objective of obtaining the reusable scene resource or the reusable object resource from the first game resources, and further achieving technical effects of improving the diversity of the reusable game resources.

In an exemplary solution, obtaining the reusable object resource from the first game resources includes:
obtaining, from a game object pool, the object resource required during the rendering of the game object related to the historical game event, the game object pool being configured for managing the reusable object resource.

Obtaining, from the game object pool, the game object resource required during the rendering of the game object related to the historical game event is an efficient management and rendering policy. The game object pool may be, but is not limited to, a mechanism for managing the reusable object resource, and can cache and reuse the object resource, to reduce resource allocation and release overheads, and improve performance and efficiency of the game. In the mobile end game, the game object pool is usually provided and managed by the game engine.

In this embodiment, when the game object in the historical game event needs to be rendered, the game engine may obtain corresponding object resources from the game object pool. These resources include reusable object resources, such as a character, a prop, and a building, and are configured for presenting a specific game object. The object resource is obtained from the game object pool, so that frequent creation and destruction of the game object can be avoided, thereby reducing system overheads and memory usage.

According to the embodiment provided in this application, the object resource required during the rendering of the game object related to the historical game event is obtained from the game object pool, the game object pool being configured for managing the reusable object resource, thereby achieving an objective of reducing the resource allocation and release overheads, and further achieving technical effects of improving the performance and efficiency of the game.

In an exemplary solution, before the reusable game resources are obtained from the first game resources, the method further includes:
performing data isolation on a game resource used during execution of a normal battle in the mobile end game and a game resource required during playing of any historical game event in the mobile end game, the normal battle including the current battle, and the any historical game event including the historical game event.

In this embodiment, during the execution of the normal battle, the game engine uses a group of specific game resources, including resources used during rendering of elements such as a character, a map, a prop, and a building, to construct the game scene and present game content. These game resources are usually dynamically loaded and rendered based on a specific situation of the current battle.

During the playing of the any historical game event, the game engine uses another group of specific game resources, including a specific role model, animation, sound effect, and the like, to restore the historical game event in a plurality of dimensions such as visual and auditory dimensions. These game resources may be pre-prepared and stored in the game engine, but are not limited thereto, and are configured for rendering and playing during execution of the historical game event.

Data isolation is performed on the game resources respectively used in the normal battle and the historical game event, so that game resources and data can be better managed and controlled, and different resources can be independently developed and maintained, to avoid mutual interference and a conflict between the resources and the data. In addition, such isolation may further improve extensibility and maintainability of the game, to facilitate upgrade and extension of the game in the future.

Performing data isolation on the game resource used during the execution of the normal battle in the mobile end game and the game resource required during the playing of the any historical game event in the mobile end game can further improve the maintainability and the extensibility of the game.

According to the embodiment provided in this application, data isolation is performed on the game resource used during the execution of the normal battle in the mobile end game and the game resource required during the playing of the any historical game event in the mobile end game, the normal battle including the current battle, and the any historical game event including the historical game event, thereby achieving an objective of performing data isolation on the game resource used during the execution of the normal battle in the mobile end game and the game resource required during the playing of the historical game event in the mobile end game, and further achieving technical effects of improving the maintainability and the extensibility of the game.

In an exemplary solution, before the performing data isolation on a game resource used during execution of a normal battle in the mobile end game and a game resource required during playing of any historical game event in the mobile end game, the method further includes:
creating a first channel list and a second channel list, the first channel list being configured for storing and managing the game resource used during the execution of the normal battle in the mobile end game, and the second channel list being configured for storing and managing the game resource required during the playing of the any historical game event in the mobile end game.

In an exemplary solution, the performing data isolation on a game resource used during execution of a normal battle in the mobile end game and a game resource required during playing of any historical game event in the mobile end game includes:
performing data isolation on the game resources respectively stored in the first channel list and the second channel list.

In this embodiment, the first channel list may be configured for storing and managing the game resource used during the execution of the normal battle, for example, the resources used during the rendering of the elements such as the character, the map, the prop, and the building. These game resources are configured for constructing the game scene and presenting the game content, and can be dynamically loaded and rendered based on the specific situation of the current battle. The game resource used during the execution of the normal battle is stored in the first channel list, so that management and control of these game resources can be facilitated, and that the game resources are loaded and used only during the execution of the normal battle is ensured.

In this embodiment, the second channel list may be configured for storing and managing the game resource required during the playing of the any historical game event, for example, game resources such as the specific character model, animation, and sound effect.

An example is further used for description. Assuming that the historical game event is an event that the virtual character loses a hit point or meets another elimination condition, and further, the resource stored and managed by using the second channel list is for presenting visual and auditory effects indicating that the character is eliminated, rendering and playing may be performed when the virtual character loses the hit point or meets the another elimination condition. The resource required for rendering the historical game event is stored in the second channel list, so that a case in which these resources are loaded and used during the execution of the normal battle can be avoided, thereby improving the performance and efficiency of the game.

To implement the data isolation, different game resources may be respectively stored and managed in the first channel list and the second channel list. In this way, the game resource used during the execution of the normal battle and the resource required during the playing of the any historical game event can be loaded, rendered, and managed independently of each other. Such data isolation can avoid mutual interference and a conflict between resources used in different situations, and improve the maintainability and extensibility of the game.

According to the embodiment provided in this application, the first channel list and the second channel list are created, the first channel list being configured for storing and managing the game resource used during the execution of the normal battle in the mobile end game, and the second channel list being configured for storing and managing the game resource required during the playing of the any historical game event in the mobile end game; and data isolation is performed on the game resources stored in the first channel list and the second channel list, thereby achieving an objective of avoiding the mutual interference and the conflict between the resources used in the different situations, and further achieving the technical effects of improving the maintainability and extensibility of the game.

In an exemplary solution, forming the second game resource based on the reusable game resources includes:
removing a redundant replay resource from the reusable game resources, to obtain the second game resource, a resource similarity between the redundant replay resource and the game resource required for the playing of the historical game event being less than or equal to a preset threshold.

In this embodiment, to remove the redundant replay resource, some algorithms and technologies may be used to analyze and compare a similarity between the game resources. The resource similarity between the redundant replay resource and the game resource required for the playing of the historical game event is calculated, so that whether the redundant replay resource and the game resource required for the playing of the historical game event are repeated or similar can be determined. If the similarity is less than or equal to the preset threshold, the redundant replay resource can be removed from the reusable game resources, to obtain the second game resource.

In addition, in this embodiment, before the redundant replay resource is removed, that the reusable game resources are complete and correct needs to be ensured, and a requirement of the historical game event can be meet. During the removing of the redundant replay resource, careful determining and filtering are required to avoid incorrect deletion of an important resource required during the rendering of the historical game event. After the redundant replay resource is removed, loading and management of the game resource need to be optimized, to improve the performance and efficiency of the game. With update and extension of the game, a game resource library needs to be updated and maintained in time, to ensure integrity and correctness of the resources.

The redundant replay resource is a game resource that is not required during execution of game replay, for example, an information interaction resource in a normal game battle. These resources are not used during event replay, but are repeatedly loaded and used during actual replay, resulting in a resource waste. The redundant replay resource is removed, so that additional performance overheads caused by the resource waste are reduced, and the adaptation degree of the real-time playing for event replay in the mobile end game is improved.

According to the embodiment provided in this application, the redundant replay resource is removed from the reusable game resources, to obtain the second game resource, the resource similarity between the redundant replay resource and the game resource required for the playing of the historical game event being less than or equal to the preset threshold, thereby achieving an objective of reducing the additional performance overheads caused by the resource waste, and further achieving technical effects of improving the adaptation degree of the real-time playing for event replay in the mobile end game.

In an exemplary solution, during rendering and playing of the historical game event based on the second game resource, the method further includes the following operations.
S4-1: Obtain a game performance parameter of a mobile device that runs the mobile end game, the game performance parameter being configured for evaluating a performance indicator of the mobile device during running of the mobile end game.
S4-2: Perform framing processing on the second game resource based on the game performance parameter, to limit a data amount of the second game resource used for rendering each frame of game picture during the playing of the historical game event, the data amount matching the game performance parameter.

In this embodiment, a resource volume required for rendering each frame in the historical game event is appropriately allocated based on the game performance parameter and the performance indicator of the mobile device. If a frame needs more resources, the frame can be separately processed and quality and smoothness of the frame can be ensured.

In this embodiment, during framing processing, consistency of pictures and effects between different frames needs to be maintained, to ensure continuity of historical game event replay and the user experience. After the framing processing, the loading and management of the resource need to be optimized. Technologies such as asynchronous loading and pre-loading are used, so that a delay and stuttering of the resource can be avoided, and a response speed and smoothness of the game can be improved.

To limit the data amount of the second game resource used for rendering each frame of game picture during the playing of the historical game event, and ensure performance and smoothness of the game, the game performance parameter of the mobile device is obtained, and framing processing is performed on the second game resource based on the game performance parameter.

An example is further used for description. First, the game performance parameter of the mobile device is obtained, so that the performance indicator, for example, a processor speed, memory usage, or battery consumption, of the mobile device during the running of the mobile end game can be evaluated. These parameters may be configured for understanding a performance bottleneck and optimization potential of the mobile device, and providing reference for subsequent game optimization. Then, framing processing is performed on the second game resource by using the game performance parameter, so that the data amount of the second game resource used for rendering each frame of game picture during the playing of the historical game event can be limited. Through analysis of the game performance parameter, the resource volume required for each frame in the historical game event can be determined, and corresponding adjustment and optimization can be performed based on the performance indicator of the device. In this way, picture smoothness and the response speed of the game can be ensured, and unnecessary data transmission and loading can be reduced.

According to the embodiment provided in this application, the game performance parameter of the mobile device is obtained, the game performance parameter being configured for evaluating the performance indicator of the mobile device during the running of mobile end game; and framing processing is performed on the second game resource based on the game performance parameter, to limit the data amount of the second game resource used for rendering each frame of game picture during the playing of the historical game event, the data amount matching the game performance parameter, thereby achieving an objective of limiting the data amount of the second game resource used for each frame of game picture during the playing of the historical game event, and further achieving technical effects of improving the performance and smoothness of the game.

In an exemplary solution, during rendering and playing of the historical game event based on the second game resource, the method further includes:
obtaining a rendering data packet transmitted through data transmission by a rendering server to the mobile device that runs the mobile end game, the rendering data packet being configured for rendering the historical game event, the rendering data packet being divided into a target amount of frame sub-data, and the target amount matching a network delay of the data transmission.

If there is too much frame sub-data, an increase of the network delay may be caused, which affects the smoothness and the response speed of the game. If there is too little frame sub-data, picture incoherence or the resource waste may be caused. Therefore, in this embodiment, balance and optimization are performed based on an actual situation, and the amount of frame sub-data obtained through division matches the network delay, to achieve optimal game performance and user experience.

An example is further used for description. The rendering server generates a rendering data packet, and the rendering data packet includes all necessary information for rendering the historical game event, such as game resources like a character model, an animation, and a sound effect. The game resources are packaged into a rendering data packet, and then the rendering data packet is transmitted to the mobile device through data transmission. Before the data transmission, to adapt to the network delay and traffic fluctuation, the rendering data packet may be divided into multiple frame sub-data. The frame sub-data may be independently transmitted and loaded, to avoid a delay and blockage that may be caused by one-time transmission of a large rendering data packet. The amount of frame sub-data may be dynamically adjusted based on a network condition, to adapt to different network environments and device performance.

After the frame sub-data is received on a mobile device end, reorganization and parsing may be performed according to a preset rule and algorithm, to restore the complete rendering data packet. Then, the rendering data packet is configured for rendering the historical game event, to present a corresponding game picture and effect.

According to the embodiment provided in this application, the rendering data packet transmitted through the data transmission by the rendering server to the mobile device is obtained, the rendering data packet being configured for rendering the historical game event, the rendering data packet being divided into the target amount of frame sub-data, and the target amount matching the network delay of the data transmission, thereby achieving an objective of performing balance and optimization based on the actual situation to cause the amount of frame sub-data obtained through division to match the network delay, and further achieving technical effects of improving the game performance and the user experience.

In an exemplary solution, after the historical game event is rendered and played based on the second game resource, the method further includes:
deleting the second game resource when a replay saving function is disabled in the mobile end game; or
saving, when the replay saving function is enabled in the mobile end game, the second game resource to local storage space of the mobile device that runs the mobile end game.

In this embodiment, when the second game resource is saved, the second game resource may be directly saved to the local storage space of the mobile device, but is not limited thereto. The local storage space may be a built-in memory or an external storage medium (for example, an SD card) of the mobile device. In addition, to save the storage space, the second game resource may be compressed before being saved. Some compression algorithms and technologies may be used to reduce a size and usage space of the data.

In the mobile end game, the second game resource can be processed based on requirements and settings of users by using different operations. If the replay saving function is disabled in the mobile end game, the second game resource may be deleted to release the storage space. If the replay saving function is enabled in the mobile end game, the second game resource may be saved to the local storage space of the mobile device for subsequent use.

In addition, when the replay saving function of the mobile end game is disabled, the second game resource may no longer need to be retained in the mobile device. To release the storage space and avoid unnecessary data redundancy, the second game resource may be deleted. A deletion operation may be automatically performed, or may be manually performed by the user. Before deletion, a backup may be created or the game resource may be marked, so that restoration is performed as required.

In addition, when the replay saving function of the mobile end game is enabled, the second game resource may be saved to the local storage space of the mobile device. In this way, it can be convenient for the user to use the game resource during replay or playing back of the game. To ensure correctness and integrity of the game resource, a saving operation is to be performed in a secure environment, and necessary encryption and protection measures are to be taken.

According to the embodiment provided in this application, the second game resource is deleted when the replay saving function is disabled in the mobile end game; or the second game resource is saved to the local storage space of the mobile device when the replay saving function is enabled in the mobile end game, thereby achieving an objective of processing the second game resource based on the requirements and settings of the users by using the different operations, and further achieving the technical effects of improving the user experience of event replay.

In an exemplary solution, for ease of understanding, the foregoing event replay method is applied to a scenario in which real-time playing of elimination replay is executed in a mobile end fps game that is based on a UE 4 engine. Due to limitations of product power and technical power and a bulky replay system module of the UE 4 engine, a function of the real-time playing of elimination replay is currently not set in the mobile end fps game that is based on the UE 4 engine on the market. This embodiment initializes a real-time elimination replay technology on a mobile end, to resolve a problem that elimination replay cannot be viewed in real time on a UE 4 mobile end.

After recorded data in an internal memory is obtained in a conventional UE 4-Replay execution manner, a new world is created through PlayReplay each time, and playing is started after a map level is loaded. Alternatively, two worlds, namely, a replay world and a real world, are created when a game starts, the two words run simultaneously in a normal battle, and the replay world is switched to when elimination replay is entered. Alternatively, DynamicLevels of a main level is copied through DuplicateLevelCollection, and DynamicLevels and a copy thereof exist in a same world. However, the foregoing cases are all limited to being used on a PC end. Specifically, this is because there are large performance overheads for the internal memory and a CPU, which is not applicable to the mobile end.

In the fps game, there is a high degree of battlefield chaos with many firing lines, and an association between skills and elimination is strong, resulting in various reasons for elimination. At a stage in which a novice player has limited control over a battlefield situation, the novice player has a higher demand for an elimination replay function in comparison with other games.

The elimination replay in this embodiment may help the player clarify an elimination reason and a location of an eliminator, to reduce frustration caused by sudden elimination and an unknown reason, and then the player can avoid elimination for a same reason next time by understanding and learning of the clarified elimination reason, and consider countermeasures. In addition, negative feedback caused by unknown elimination is reduced, and an enemy operation is learned through viewing at an enemy elimination viewing angle.

In addition, in terms of information presentation of the elimination replay in this embodiment, through elimination replay, the player can clarify at least one of the following information and learn from the information, for example, clarify a specific eliminator, clarify locations of both parties when the eliminator eliminates the player, clarify an elimination means used by the eliminator to eliminate the player, and clarify a preparation operation of the eliminator in a period of time before the eliminator eliminates the player, so that a viewer clearly perceives that this is an elimination lens rather than battle viewing, to avoid a doubt.

In this embodiment, a video recording system built in the UE 4 provides a capability of saving network data for this embodiment. A video recording network driver (DemoNetDriver) on a server pushes network synchronization data to a video recording streamer (Replay Streamer), and the streamer saves the network data in a form of a video recording file. On a client, after the video recording file is picked up in this embodiment, the video recording file is deserialized into the network data through the streamer, and the network data is finally reproduced as a game scene through DemoNetDriver.

In this embodiment, an AcotrPoolSubsystem object pool technology is customized for the UE engine. The object pool technology (Actor Pooling) is a design manner for optimizing performance and resource utilization, and is usually configured for managing and repeatedly using an object that can be repeatedly created and destroyed. The object pool technology may use an existing object at a place in which an object needs to be created, to avoid frequently performing object creation and destruction operations, so as to improve system performance and efficiency. An object pool may include, but is not limited to, a pre-created object set (pool). When an object is needed, an idle object is obtained from the pool, and is returned to the pool after use is completed, rather than destroying the object. In this way, overheads of repeatedly creating and destructing the object can be avoided, thereby saving system resources, and reducing fragmentation of the internal memory. A frequency of object allocation and garbage collection can be reduced by using the object pool technology, to reduce system overheads. This is often used in scenarios such as game development, a network server, and concurrent programming, to improve performance and a response speed.

In this embodiment, a level reuse technology is configured for implementing sharing and reuse of a plurality of levels. During game development, there are usually a plurality of levels or level scenarios, and each of the levels has content such as a design, a map, a prop, and an enemy of the level. However, sometimes, some levels may have similar structures or elements. Therefore, sharing and reuse of the levels may be implemented through some technical means, to reduce repetitive work and resource consumption. Through the level reuse technology, a developer can more efficiently design and create a level, to reduce workload and ensure consistency and quality between levels. In addition, the level reuse technology may also reduce memory usage and loading time, to improve game performance and user experience.

An example is further used for description. For example, as shown in FIG. 6, when a game is entered, a normal network synchronization driver IPNetDriver is created for a procedure of network packet synchronization serialization and deserialization. In a post elimination battle viewing interface, as shown in FIG. 7, a defeat replay button (a button shown by a white box on the right side in FIG. 7) is newly added above an elimination flow. The defeat replay button is set to be gray and has a countdown initially, and the elimination replay can be clicked to enter only after the countdown ends.

Before the countdown ends, the server transmits a network data stream recorded by DemoNetDriver to the client for caching, and scene switching is performed when playing is needed. Herein, accuracy of scene restoration and recovery during scene switching needs to be ensured. Then, in this embodiment, a concise data sheet (DS) message recording manner and lightweight DemoNetDriver are used. A replay client manages two channel lists for performing isolation processing and service processing for a project, and a series of systems are isolated, to avoid affecting accuracy of in-battle scene/replay scene data. For example, a player state and a game state correspond to related system processing.

Before the defeat replay button is clicked, and the elimination replay is entered, game objects (Actors) in a normal combat scene are hidden, and a network packet is cached and synchronization of the network packet is paused, to ensure restoration of the normal combat scene. To avoid stuttering in a client transition scene and alleviate performance pressure on a mobile phone, no-load mapping reuses a level of normal combat in an original battle, and unloading and additional loading are no longer performed, to reduce a lot of performance consumption. In addition, in this embodiment, a game object (SpawnActor) is spawned by using an ActorPoolSubsystem-Resue technology, to greatly improve execution efficiency, and finally implement rapid switching between the normal combat scene and a replay scene. Furthermore, useless performance overheads caused by service redundancy, such as some useless data in the player state and the game state, are reduced, to avoid overheads caused by unnecessary registration and binding processing. The SpawnActor performs framing processing, to avoid stuttering caused by performance backlog due to a fact that a large quantity of actors are spawned. Because pre-loading of all resources in the normal combat scene is completed, there is no need to load any resource in this case, to avoid stuttering caused by loading the resource.

In this embodiment, to avoid synchronization stuttering during packet receiving by the client caused by a case that the DS transmits backlog traffic and alleviate traffic pressure on the mobile phone, DS framing is performed to transmit a remote procedure call (RPC) message, to avoid cleaning the channel list under DemoNetDriver in this embodiment after a client link reaches a buffer saturation state, and the elimination replay exits. The previously hidden actors in the normal combat scene are displayed, and synchronization of the network packet is restored, to restore the normal combat scene.

According to the embodiment provided in this application, the real-time elimination replay technology on the mobile end is provided, to resolve the problem that the elimination replay cannot be viewed in real time on the UE 4 mobile end.

In specific implementations of this application, when data related to user information and the like in embodiments of this application is used in specific products or technologies, user permission or consent needs to be obtained, and collection, use, and processing of related data need to comply with relevant laws, regulations, and standards of relevant countries and regions.

For ease of description, the foregoing method embodiments are described as a series of action combinations. However, it is to be understood by a person skilled in the art that, this application is not limited to the described order of the actions because some operations may be performed in other orders or simultaneously according to this application. In addition, it is to be understood by a person skilled in the art that, the embodiments described in the specification are all exemplary embodiments, and the related actions and modules are not necessarily required in this application.

According to another aspect of embodiments of this application, an event replay apparatus configured to implement the foregoing event replay method is further provided. As shown in FIG. 8, the apparatus includes:
a first display unit 802, configured to display a running picture of a mobile end game, the running picture being a picture obtained through rendering based on first game resources, and the first game resource being a game resource used during execution of a current battle in the mobile end game;
a first obtaining unit 804, configured to: obtain reusable game resources from the first game resources, and form a second game resource based on the reusable game resources in response to an event replay request, the event replay request being configured for requesting to replay a historical game event of a virtual character, and the second game resource being a game resource required during rendering and playing of the historical game event; and
a playing unit 806, configured to render and play the historical game event based on the second game resource during the execution of the current battle in the mobile end game.

For a specific embodiment, refer to the example shown in the foregoing event replay method. Details are not described herein again in this example.

In an exemplary solution, the apparatus further includes:
a second display unit, configured to display, before the reusable game resources are obtained from the first game resources, and the second game resource is formed based on the reusable game resources in response to the event replay request, an event replay control when the historical game event is in an end state, the historical game event in the end state being set to prohibit a change; and
a second obtaining unit, configured to initiate, before the reusable game resources are obtained from the first game resources, and the second game resource is formed based on the reusable game resources in response to the event replay request, the event replay request in response to a replay trigger operation executed based on the event replay control.

For a specific embodiment, refer to the example shown in the foregoing event replay method. Details are not described herein again in this example.

In an exemplary solution, the apparatus further includes:
a third display unit, configured to display the event replay control in an operation prohibited state and countdown time of the operation prohibited state during displaying of the event replay control, the event replay control in the operation prohibited state being set to prohibit execution of the replay trigger operation; and
a fourth display unit, configured to display, during displaying of the event replay control, the event replay control in an operation allowed state when the countdown time of the operation prohibited state is cleared, the event replay control in the operation allowed state being set to allow the execution of the replay trigger operation.

For a specific embodiment, refer to the example shown in the foregoing event replay method. Details are not described herein again in this example.

In an exemplary solution, the first obtaining unit 804 includes at least one of the following:
a first obtaining module, configured to obtain a reusable scene resource from the first game resources, the scene resource being a resource required during rendering of a game scene of the current battle; and
a second obtaining module, configured to obtain a reusable object resource from the first game resources, the object resource being a resource required during rendering of a game object related to the historical game event in the current battle.

For a specific embodiment, refer to the example shown in the foregoing event replay method. Details are not described herein again in this example.

In an exemplary solution, the second obtaining module includes:
an obtaining submodule, configured to obtain, from a game object pool, the object resource required during the rendering of the game object related to the historical game event, the game object pool being configured for managing the reusable object resource.

For a specific embodiment, refer to the example shown in the foregoing event replay method. Details are not described herein again in this example.

In an exemplary solution, the apparatus further includes:
an isolation unit, configured to perform, before the reusable game resources are obtained from the first game resources, data isolation on a game resource used during execution of a normal battle in the mobile end game and a game resource required during playing of any historical game event in the mobile end game, the normal battle including the current battle, and the any historical game event including the historical game event.

For a specific embodiment, refer to the example shown in the foregoing event replay method. Details are not described herein again in this example.

In an exemplary solution, the apparatus further includes: a creation unit, configured to create a first channel list and a second channel list before data isolation is performed on the game resource used during the execution of the normal battle in the mobile end game and the game resource required during the playing of the any historical game event in the mobile end game, the first channel list being configured for storing and managing the game resource used during the execution of the normal battle in the mobile end game, and the second channel list being configured for storing and managing the game resource required during the playing of the any historical game event in the mobile end game.

The isolation unit includes: an isolation module, configured to perform data isolation on the game resources respectively stored in the first channel list and the second channel list.

For a specific embodiment, refer to the example shown in the foregoing event replay method. Details are not described herein again in this example.

In an exemplary solution, the first obtaining unit 804 includes:
a removing module, configured to remove a redundant replay resource from the reusable game resources, to obtain the second game resource, a resource similarity between the redundant replay resource and the game resource required for the playing of the historical game event being less than or equal to a preset threshold.

For a specific embodiment, refer to the example shown in the foregoing event replay method. Details are not described herein again in this example.

In an exemplary solution, the apparatus further includes:
a third obtaining unit, configured to obtain, during the rendering and playing of the historical game event based on the second game resource, a game performance parameter of a mobile device that runs the mobile end game, the game performance parameter being configured for evaluating a performance indicator of the mobile device during running of mobile end game; and
a framing unit, configured to perform framing processing, during the rendering and playing of the historical game event based on the second game resource, on the second game resource based on the game performance parameter, to limit a data amount of the second game resource used for rendering each frame of game picture during the playing of the historical game event, the data amount matching the game performance parameter.

For a specific embodiment, refer to the example shown in the foregoing event replay method. Details are not described herein again in this example.

In an exemplary solution, the apparatus further includes:
a fourth obtaining unit, configured to obtain, during the rendering and playing of the historical game event based on the second game resource, a rendering data packet transmitted through data transmission by a rendering server to the mobile device that runs the mobile end game, the rendering data packet being configured for rendering the historical game event, the rendering data packet being divided into a target amount of frame sub-data, and the target amount matching a network delay of the data transmission.

For a specific embodiment, refer to the example shown in the foregoing event replay method. Details are not described herein again in this example.

In an exemplary solution, the apparatus further includes:
a management unit, configured to: delete, after the rendering and playing of the historical game event based on the second game resource, the second game resource when a replay saving function is disabled in the mobile end game; or save, when the replay saving function is enabled in the mobile end game, the second game resource to local storage space of the mobile device that runs the mobile end game.

For a specific embodiment, refer to the example shown in the foregoing event replay method. Details are not described herein again in this example.

According to still another aspect of embodiments of this application, an electronic device configured to implement the foregoing event replay method is further provided. The electronic device may be, but is not limited to, the user equipment 102 or the server 112 shown in FIG. 1. In this embodiment, an example in which the electronic device is the user equipment 102 is used for description. Further, as shown in FIG. 9, the electronic device includes a memory 902 and a processor 904. The memory 902 stores a computer program. The processor 904 is configured to perform the operation in any one of the foregoing method embodiments by using the computer program.

In this embodiment, the electronic device may be located in at least one of a plurality of network devices in a computer network.

In this embodiment, the processor may be configured to perform the foregoing event replay method by using the computer program.

A person of ordinary skill in the art may understand that, the structure shown in FIG. 9 is merely an example, and FIG. 9 does not constitute a limitation to the structure of the electronic device. For example, the electronic device may also include more or fewer components (for example, a network interface) than those shown in FIG. 9, or have a configuration different from that shown in FIG. 9.

The memory 902 may be configured to store a software program and a module, for example, program instructions/modules corresponding to the real-time playing method and apparatus for event replay in embodiments of this application. The processor 904 performs various functional applications and data processing by running the software program and the module stored in the memory 902, to implement the foregoing real-time playing method for event replay. The memory 902 may include a high-speed random access memory, and may further include a non-volatile memory, for example, one or more magnetic storage apparatuses, a flash memory, or another non-volatile solid-state memory. In some embodiments, the memory 902 may further include memories remotely disposed relative to the processor 904, and the remote memories may be connected to the electronic device via a network. Examples of the network include, but are not limited to, the internet, an enterprise intranet, a local area network, a mobile communication network, and a combination thereof. The memory 902 may be specifically configured to store information such as a running picture, a first game resource, and a second game resource, but is not limited thereto. In an example, as shown in FIG. 9, the memory 902 may include, but is not limited to, the first display unit 802, the first obtaining unit 804, and the playing unit 806 in the foregoing real-time playing apparatus for event replay. In addition, the memory 902 may further include, but is not limited to, another module unit in the foregoing real-time playing apparatus for event replay. Details are not described in this example.

A transmission apparatus 906 is configured to receive or transmit data via a network. Specific examples of the network may include a wired network and a wireless network. In an example, the transmission apparatus 906 includes a network interface controller (NIC), and the network interface controller may be connected to another network device and a router through a network cable, so that communication with the internet or a local area network can be implemented. In an example, the transmission apparatus 906 is a radio frequency (RF) module, and is configured to communicate with the internet in a wireless manner.

In addition, the electronic device further includes: a display 908, configured to display the information such as the running picture, the first game resource, and the second game resource; and a connection bus 910, configured to connect module components in the electronic device.

In another embodiment, the user equipment or the server may be a node in a distributed system. The distributed system may be a blockchain system, and the blockchain system may be a distributed system formed by connecting a plurality of nodes in a form of network communication. The nodes may form a point-to-point network, and any form of computing device, for example, an electronic device like a server or user equipment, can become a node in the blockchain system by joining the point-to-point network.

According to an aspect of this application, a computer program product is provided. The computer program product includes a computer program/instructions, and the computer program/instructions include program code for performing the method shown in the flowchart. In such an embodiment, the computer program may be downloaded and installed from a network, and/or installed from a removable medium through a communication part. When the computer program is executed by a central processing unit, various functions provided in embodiments of this application are performed.

The sequence numbers of embodiments of this application are merely used for description, and do not indicate preference of the embodiments.

A computer system of the electronic device is merely an example, and is not to bring any limitation to functions and use scope of embodiments of this application.

The computer system includes a central processing unit (CPU), and the CPU may perform various appropriate actions and processing based on a program stored in a read-only memory (ROM) or a program loaded from a storage part to a random access memory (RAM). In the random access memory, various programs and data required for system operations are also stored. The central processing unit, the read-only memory, and the random access memory are connected to each other through a bus. An input/output interface (namely, an I/O interface) is also connected to the bus.

The following components are connected to the input/output interface, including an input part, for example, a keyboard or a mouse; an output part, for example, a cathode ray tube (CRT), a liquid crystal display (LCD), and a speaker; a storage part, for example, a hard disk; and a communication part of a network interface card, for example, a local area network card or a modem. The communication part performs communication processing via a network, for example, the internet. A driver is also connected to the input/output interface based on a requirement. The removable medium, for example, a magnetic disk, an optical disc, a magneto-optical disk, or a semiconductor memory, is installed on the driver based on a requirement, so that a computer program read from the removable medium is installed into the storage part based on a requirement.

Specifically, according to embodiments of this application, processes described in a flowchart of each method may be implemented as a computer software program. For example, an embodiment of this application includes a computer program product, including a computer program carried in a computer-readable medium. The computer program includes program code for performing the method shown in the flowchart. In such an embodiment, the computer program may be downloaded and installed from a network, and/or installed from a removable medium through a communication part. When the computer program is executed by a central processing unit, various functions defined in the system of this application are performed.

According to an aspect of this application, a non-transitory computer-readable storage medium is provided. A processor of a computer device reads computer instructions from the computer-readable storage medium, and the processor executes the computer instructions, to cause the computer device to perform the method provided in the foregoing exemplary implementations.

In this embodiment, the computer-readable storage medium may be configured to store a computer program for performing the foregoing event replay method.

In the embodiments, a person of ordinary skill in the art may understand that, all or a part of operations of the method in the foregoing embodiments may be implemented by using a program instructing hardware related to an electronic device. The program may be stored in a computer-readable storage medium. The storage medium may include a flash drive, a read-only memory (ROM), a random access memory (RAM), a magnetic disk, an optical disc, and the like.

The sequence numbers of embodiments of this application are merely used for description, and do not indicate preference of the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this application essentially, or the part contributing to the related art, or all or a part of the technical solutions may be implemented in a form of a software product. The computer software product is stored in a storage medium and includes several instructions for instructing one or more computer devices (which may be a personal computer, a server, a network device, or the like) to perform all or a part of operations of the method described in embodiments of this application.

In the foregoing embodiments of this application, descriptions of the embodiments have respective focuses. For a part that is not described in detail in an embodiment, refer to related descriptions in other embodiments.

In several embodiments provided in this application, the disclosed user equipment may be implemented in other manners. The apparatus embodiments described above are merely exemplary. For example, division of the units is merely logical function division and there may be another division manner in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic or other forms.

The units described as separate components may or may not be physically separate, and components displayed as units may or may not be physical units, to be specific, may be located in one place, or may be distributed on a plurality of network units. A part or all of the units may be selected based on an actual requirement to achieve the objectives of the solutions of the embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

The foregoing descriptions are merely exemplary implementations of this application. A person of ordinary skill in the art may make some improvements and modifications without departing from the principle of this application. Such improvements and modifications fall within the protection scope of this application.

What is claimed is:

1. An event replay method performed by an electronic device, the method comprising:
displaying a running picture of a mobile end game on a display of the electronic device obtained through rendering based on first game resources used during execution of a current battle in the mobile end game;
receiving an event replay request by a user of the electronic device, the event replay request being configured for requesting to replay a historical game event of a virtual character in the mobile end game;
obtaining reusable game resources from the first game resources;
forming second game resources based on the reusable game resources, the second game resources required during rendering and playing of the historical game event; and
rendering and playing the historical game event based on the second game resources during the execution of the current battle in the mobile end game.

2. The method according to claim 1, wherein the receiving the event replay request by the user of the electronic device further comprises:
displaying an event replay control when the historical game event is in an end state, the historical game event in the end state being set to prohibit a change; and
initiating the event replay request in response to a replay trigger operation executed on the event replay control by the user of the electronic device.

3. The method according to claim 2, wherein the method further comprises:
displaying the event replay control in an operation prohibited state and countdown time of the operation prohibited state, the event replay control in the operation prohibited state being set to prohibit execution of the replay trigger operation; and
displaying the event replay control in an operation allowed state when the countdown time of the operation prohibited state is cleared, the event replay control in the operation allowed state being set to allow the execution of the replay trigger operation.

4. The method according to claim 1, wherein the obtaining reusable game resources from the first game resources comprises at least one of the following:
obtaining a reusable scene resource from the first game resource required during rendering of a game scene of the current battle; and
obtaining a reusable object resource from the first game resources required during rendering of a game object related to the historical game event in the current battle.

5. The method according to claim 1, wherein before the obtaining reusable game resources from the first game resources, the method further comprises:
performing data isolation on a game resource used during execution of a normal battle in the mobile end game and a game resource required during playing of any historical game event in the mobile end game, the normal battle comprising the current battle, and the any historical game event comprising the historical game event.

6. The method according to claim 1, wherein the forming the second game resources based on the reusable game resources comprises:
removing a redundant replay resource from the reusable game resources, to obtain the second game resource, a resource similarity between the redundant replay resource and the game resource required for the playing of the historical game event being less than or equal to a preset threshold.

7. The method according to claim 1, wherein during the rendering and playing the historical game event based on the second game resource, the method further comprises:
obtaining a game performance parameter of a mobile device that runs the mobile end game, the game performance parameter being configured for evaluating a performance indicator of the mobile device during running of the mobile end game; and
performing framing processing on the second game resource based on the game performance parameter, to limit a data amount of the second game resource used for rendering each frame of game picture during the playing of the historical game event, the data amount matching the game performance parameter.

8. The method according to claim 1, wherein during the rendering and playing the historical game event based on the second game resource, the method further comprises:
obtaining a rendering data packet transmitted through data transmission by a rendering server to the mobile device that runs the mobile end game, the rendering data packet being configured for rendering the historical game event, the rendering data packet being divided into a target amount of frame sub-data, and the target amount matching a network delay of the data transmission.

9. The method according to claim 1, wherein after the rendering and playing the historical game event based on the second game resource, the method further comprises:
deleting the second game resource when a replay saving function is disabled in the mobile end game; or
saving, when the replay saving function is enabled in the mobile end game, the second game resource to local storage space of the mobile device that runs the mobile end game.

10. An electronic device, comprising a memory and a processor, the memory having a computer program stored therein, and the computer program, when executed by the processor, causing the electronic device to perform an event replay method including:
displaying a running picture of a mobile end game on a display of the electronic device obtained through rendering based on first game resources used during execution of a current battle in the mobile end game;
receiving an event replay request by a user of the electronic device, the event replay request being configured for requesting to replay a historical game event of a virtual character in the mobile end game;
obtaining reusable game resources from the first game resources;
forming second game resources based on the reusable game resources, the second game resources required during rendering and playing of the historical game event; and
rendering and playing the historical game event based on the second game resources during the execution of the current battle in the mobile end game.

11. The electronic device according to claim 10, wherein the receiving the event replay request by the user of the electronic device further comprises:
displaying an event replay control when the historical game event is in an end state, the historical game event in the end state being set to prohibit a change; and
initiating the event replay request in response to a replay trigger operation executed on the event replay control by the user of the electronic device.

12. The electronic device according to claim 11, wherein the method further comprises:
displaying the event replay control in an operation prohibited state and countdown time of the operation prohibited state, the event replay control in the operation prohibited state being set to prohibit execution of the replay trigger operation; and
displaying the event replay control in an operation allowed state when the countdown time of the operation prohibited state is cleared, the event replay control in the operation allowed state being set to allow the execution of the replay trigger operation.

13. The electronic device according to claim 10, wherein the obtaining reusable game resources from the first game resources comprises at least one of the following:
obtaining a reusable scene resource from the first game resource required during rendering of a game scene of the current battle; and
obtaining a reusable object resource from the first game resources required during rendering of a game object related to the historical game event in the current battle.

14. The electronic device according to claim 10, wherein before the obtaining reusable game resources from the first game resources, the method further comprises:
performing data isolation on a game resource used during execution of a normal battle in the mobile end game and a game resource required during playing of any historical game event in the mobile end game, the normal battle comprising the current battle, and the any historical game event comprising the historical game event.

15. The electronic device according to claim 10, wherein the forming the second game resources based on the reusable game resources comprises:
removing a redundant replay resource from the reusable game resources, to obtain the second game resource, a resource similarity between the redundant replay resource and the game resource required for the playing of the historical game event being less than or equal to a preset threshold.

16. The electronic device according to claim 10, wherein during the rendering and playing the historical game event based on the second game resource, the method further comprises:
obtaining a game performance parameter of a mobile device that runs the mobile end game, the game performance parameter being configured for evaluating a performance indicator of the mobile device during running of the mobile end game; and
performing framing processing on the second game resource based on the game performance parameter, to limit a data amount of the second game resource used for rendering each frame of game picture during the playing of the historical game event, the data amount matching the game performance parameter.

17. The electronic device according to claim 10, wherein during the rendering and playing the historical game event based on the second game resource, the method further comprises:
obtaining a rendering data packet transmitted through data transmission by a rendering server to the mobile device that runs the mobile end game, the rendering data packet being configured for rendering the historical game event, the rendering data packet being divided into a target amount of frame sub-data, and the target amount matching a network delay of the data transmission.

18. The electronic device according to claim 10, wherein after the rendering and playing the historical game event based on the second game resource, the method further comprises:
deleting the second game resource when a replay saving function is disabled in the mobile end game; or
saving, when the replay saving function is enabled in the mobile end game, the second game resource to local storage space of the mobile device that runs the mobile end game.

19. A non-transitory computer-readable storage medium having a computer program stored therein, and the computer program, when executed by a processor of an electronic device, causing the electronic device to perform an event replay method including:
displaying a running picture of a mobile end game on a display of the electronic device obtained through rendering based on first game resources used during execution of a current battle in the mobile end game;
receiving an event replay request by a user of the electronic device, the event replay request being configured for requesting to replay a historical game event of a virtual character in the mobile end game;
obtaining reusable game resources from the first game resources;
forming second game resources based on the reusable game resources, the second game resources required during rendering and playing of the historical game event; and
rendering and playing the historical game event based on the second game resources during the execution of the current battle in the mobile end game.

20. The non-transitory computer-readable storage medium according to claim 19, wherein the receiving the event replay request by the user of the electronic device further comprises:
displaying an event replay control when the historical game event is in an end state, the historical game event in the end state being set to prohibit a change; and
initiating the event replay request in response to a replay trigger operation executed on the event replay control by the user of the electronic device.
